(19) United States
(12) Patent Application Publication
(10) Pub. No.: US 2024/0188181 A1
(43) Pub. Date: Jun. 6, 2024

(54) METHODS AND APPARATUSES FOR SIDELINK COMMUNICATION

(71) Applicant: LENOVO (BEIJING) LIMITED, Beijing (CN)

(72) Inventors: Jing Han, Beijing (CN); Congchi Zhang, Shanghai (CN); Lianhai Wu, Beijing (CN); Haiming Wang, Beijing (CN); Mingzeng Dai, Shanghai (CN); Jie Shi, Beijing (CN)

(21) Appl. No.: 18/554,837

(22) PCT Filed: Apr. 11, 2021
(86) PCT No.: PCT/CN2021/086317

§ 371 Date: Oct. 11, 2023

(51) Int. Cl. H04W 76/28; H04W 92/18

(52) U.S. Cl. CPC H04W 76/28; H04W 92/18

(57) ABSTRACT

The present disclosure relates to methods and apparatuses for sidelink (SL) communication with discontinuous reception (DRX). One embodiment of the present disclosure provides a method for resource selection, which includes: determining time information of a sidelink (SL) Discontinuous Reception (DRX) configuration for SL data transmission; determining a resource set based on the time information and resources indicated by a physical layer, and selecting one or more resources from the resource set for SL data transmission.

### TECHNICAL FIELD

The present disclosure relates to wireless communication technology, especially to methods and apparatuses for sidelink (SL) communication with discontinuous reception (DRX).

### BACKGROUND OF THE INVENTION

Discontinuous reception refers to a working mode for saving power consumption of a user equipment (UE). For example, generally, in the DRX mode, the UE alternates between an active state and a sleep state (or an inactive state). The UE only turns on the receiver to monitor and receive control information or data when it is in the active state, and turns off the receiver to stop receiving the control information or data when it is in the sleep state.

Given this, the UE may not be able to successfully transmit the SL data if not aware of the DRX configuration.

### SUMMARY

One embodiment of the present disclosure provides a method for resource selection, which includes: determining time information of a sidelink (SL) Discontinuous Reception (DRX) configuration for SL data transmission; determining a resource set based on the time information and resources indicated by a physical layer, and selecting one or more resources from the resource set for SL data transmission.

In an embodiment of the present disclosure, the SL DRX configuration is associated with a corresponding Quality of Service (QOS) related parameter, a corresponding destination, a corresponding source, or a corresponding logical channel.

In an embodiment of the present disclosure, the time information includes one or more transmission durations for SL data transmission that associated with a logical channel.

In an embodiment of the present disclosure, the time information includes one or more next transmission durations for a single Media Access Control (MAC) Protocol Data Unit (PDU) transmission.

In an embodiment of the present disclosure, the time information includes one or more periodic transmission durations for multiple MAC PDU transmissions.

In an embodiment of the present disclosure, the method further includes determining a logical channel for a SL process with no selected SL grant being created for the SL data transmission that associated with the logical channel.

In an embodiment of the present disclosure, the method further includes determining a logical channel for a SL process with no selected SL grant being created for SL data transmission in a transmission duration of the logical channel.

In an embodiment of the present disclosure, the method further includes determining a logical channel for a SL process with a highest priority among multiple logical channels that has data and starved, and optionally wherein the logical channel has no SL grant being created for SL data transmission in a transmission duration of the logical channel.

In an embodiment of the present disclosure, the method further includes determining a logical channel for a SL process with no selected SL grant being created for SL data transmission of an associated destination of the logical channel.

In an embodiment of the present disclosure, the method further includes associating one or more logical channels having a same destination and/or SL DRX configuration with determined logical channel.

In an embodiment of the present disclosure, the method further includes performing resource selection check or resource selection for a determined logical channel.

In an embodiment of the present disclosure, the method further includes determining a SL DRX configuration whose associated logical channels has data for transmission; and determining a first logical channel which is selected from multiple logical channels associated with the SL DRX configuration and has the highest priority and with data to be transmitted.

In an embodiment of the present disclosure, the method further includes performing resource selection check for the SL DRX configuration and the determined logical channel.

In an embodiment of the present disclosure, the method further includes selecting resource for the SL DRX configuration and the determined logical channel when a created SL grant is not suitable for the SL DRX configuration, or no SL grant is created for the SL DRX configuration.

In an embodiment of the present disclosure, the method further includes associating one or more logical channels with determined logical channel, wherein the one or more logical channels have data to be transmitted and have a same destination and/or SL DRX configuration with the determined logical channel.

Another embodiment of the present disclosure provide an apparatus, which includes: a processor; and a transceiver coupled to the processor, wherein the processor is configured to: determine time information of a sidelink (SL) Discontinuous Reception (DRX) configuration for SL data transmission; determine a resource set based on the time information and resources indicated by a physical layer, and select one or more resources from the resource set for SL data transmission.

### BRIEF DESCRIPTION OF THE DRAWINGS

FIG. 1 illustrates an exemplary sidelink communication system, in accordance with some embodiments of the present disclosure

FIG. 2 illustrates a SL grant creation procedure performed by a UE in mode 2, according to some embodiments of the present disclosure.

FIG. 3 illustrates another SL grant creation procedure performed by a UE in mode 2 according to some embodiments of the present disclosure.

FIG. 4 illustrates another SL grant creation procedure performed by a UE in mode 2 according to some embodiments of the present disclosure.

FIG. 5 illustrates a method performed by a UE for sidelink communication according to some embodiments of the present disclosure.

FIG. 6 illustrates an exemplary block diagram of a UE according to some embodiments of the present disclosure.

### DETAILED DESCRIPTION

The detailed description of the appended drawings is intended as a description of the currently preferred embodiments of the present invention, and is not intended to represent the only form in which the present invention may be practiced. It should be understood that the same or equivalent functions may be accomplished by different embodiments that are intended to be encompassed within the spirit and scope of the present invention.

While operations are depicted in the drawings in a particular order, persons skilled in the art will readily recognize that such operations need not be performed in the particular order shown or in sequential order, or that all illustrated operations be performed, to achieve desirable results, sometimes one or more operations can be skipped. Further, the drawings can schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing can be advantageous.

The detailed description of the appended drawings is intended as a description of the preferred embodiments of the present invention, and is not intended to represent the only form in which the present invention may be practiced. It should be understood that the same or equivalent functions may be accomplished by different embodiments that are intended to be encompassed within the spirit and scope of the present invention.

Reference will now be made in detail to some embodiments of the present disclosure, examples of which are illustrated in the accompanying drawings. To facilitate understanding, embodiments are provided under specific network architecture and new service scenarios, such as 3^{rd} Generation Partnership Project (3GPP) 3G, 3GPP 5G, 3GPP long-term evolution (LTE), LTE-Advanced (LTE-A), 3GPP 4G, 3GPP 5G NR. 3GPP LTE Release 12 and onwards, etc. It can be contemplated that along with the 3GPP and related communication technology development, the terminologies recited in the present disclosure may change, which should not affect the principle of the present disclosure.

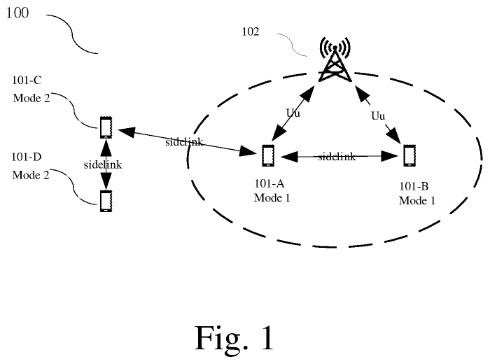

FIG. 1 illustrates an exemplary sidelink communication system in accordance with some embodiments of the present disclosure.

As shown in FIG. 1, the sidelink communication system includes a base station, i.e., BS 102 and some UEs, i.e., UE 101-A, UE 101-B, UE 101-C. and UE 101-D. UE 101-A and UE 101-B are within the coverage of BS 102, and UE 101-C and UE 101-D are not. UE 101-A. UE 101-B, UE 101-C, and UE 101-D may perform sidelink unicast transmission, sidelink groupcast transmission, or sidelink broadcast transmission. It can be contemplated that, in accordance with some other embodiments of the present disclosure, a sidelink communication system may include more or fewer BSs, and more or fewer UEs. Moreover, it can be contemplated that names of UEs (which represent a Tx UE, a Rx UE, and etc.) as illustrated and shown in FIG. 1 may be different, e.g., UE 104f, and UE 108g or the like.

In addition, although UE 101-A as shown in FIG. 1 is illustrated in the shape of a phone, it can be contemplated that a sidelink communication system may include any type of UE (e.g., a roadmap device, a cell phone, a computer, a laptop, IoT (internet of things) device or other type of device) in accordance with some other embodiments of the present disclosure.

UE 101-A and UE 101-C may function as transmitting (Tx) UEs, and UE 101-B and UE 101-D function as receiving (Rx) UEs. UE 101-A may exchange messages with UE 101-B, or UE 101-C through a sidelink, for example, PC5 interface as defined in 3GPP documents. UE 101-A may transmit information or data to other UE(s) within the sidelink communication system, through sidelink unicast, sidelink groupcast, or sidelink broadcast. For instance, UE 101-A may transmit data to UE 101-B in a sidelink unicast session. UE 101-A may transmit data to UE 101-B and UE 101-C in a groupcast group by a sidelink groupcast transmission session. Also, UE 101-A may transmit data to UE 101-B and UE 101-C by a sidelink broadcast transmission session.

Both UE 101-A and UE 101-B in the embodiments of FIG. 1 may transmit information to BS 102 and receive control information from BS 102, for example, via NR Uu interface. BS 102 may define one or more cells, and each cell may have a coverage area. As shown in FIG. 1, both UE 101-A and UE 101-B are within the coverage of BS 102, and UE 101-C is outside of the coverage of BS 102.

BS 102 as illustrated and shown in FIG. 1 is not a specific base station, but may be any base station(s) in the sidelink communication system. For example, if the sidelink communication system includes two BSs 102, UE 101-A being within a coverage area of any one the two BSs 102 may be called as a case that UE 101-A is within a coverage of BS 102 in the sidelink communication system; and only UE 101-A being outside of coverage area(s) of both BSs 102 can be called as a case that UE 101-A is outside of the coverage of BS 102 in the sidelink communication system.

The UEs may operate in different modes. At least two sidelink resource allocation modes are defined for NR sidelink communication, which are:
1) mode 1: base station schedules sidelink resource(s) to be used by the UE for sidelink transmission(s); and
2) mode 2: the UE determines sidelink transmission resource(s) within sidelink resources configured by the BS or network, or pre-configured sidelink resources; in mode 2, the BS does not schedule the sidelink resources for the UE.

In FIG. 1, UE 101-A and UE 101-B are in mode 1, and UE 101-C and UE 101-D are in mode 2.

The UEs in FIG. 1 may be pedestrian UEs, which are power sensitive, and it is desirable for the UE to reduce the energy consumption. Since a transmission data stream is usually a burst, that is, there is data transmission only within a certain period of time, the device serving as a receiving terminal can stop detecting when there is no data transmission, thereby the UEs in FIG. 1 also utilize the DRX mode to save power.

The present disclosure focuses on the communications among UEs in mode 2, which includes broadcast, groupcast and unicast, and the UEs also utilizes the DRX mode to save power.

The SL DRX configuration may be configured per PQI (PC5 5G QoS Identifier (5Q1)) or per QoS, per destination, or per logical channel, etc. In this case, UE will maintain one or more SL DRX configurations for broadcast, groupcast and unicast, and UE needs to transmit data according to the corresponding SL DRX configuration.

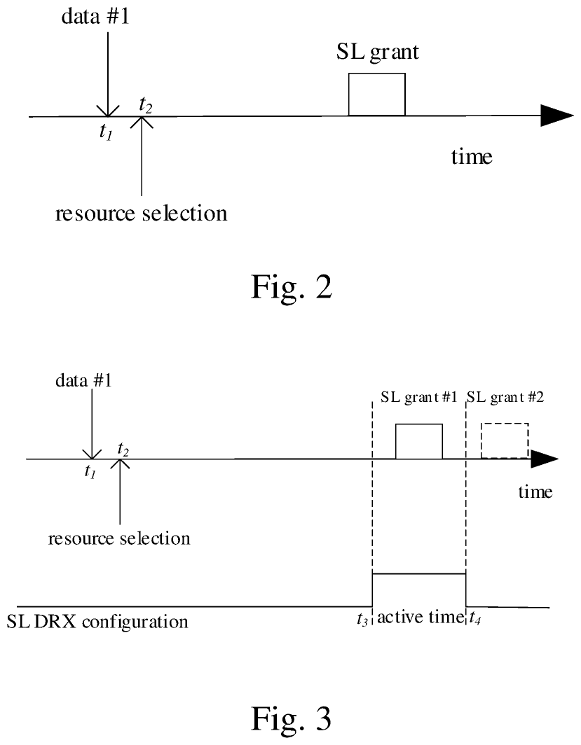

FIG. 2 illustrates a SL grant creation procedure performed by a UE in mode 2 according to some embodiments of the present disclosure.

In FIG. 2, at time t₁, data #1 in logical channel #1 is to be transmitted on sidelink. In this case, at time t₂, the MAC entity may create a SL grant for this SL data transmission. The SL grant is within a time slot in time domain and within one or more sub-channels in frequency domain.

Currently, the resource selection procedure for a mode 2 UE may include the following steps:
1) Step 1: for each sidelink process, the MAC entity may create a SL grant, which includes resource pool selection, resource selection check or resource reselection check, and resource selection, and the MAC entity derive physical sidelink shared channel (PSSCH) and physical sidelink shared channel (PSCCH) duration according to the SL grant.
2) Step 2: for each PSSCH duration, the MAC entity may select modulation coding scheme (MCS), set resource reservation interval, and deliver SL grant and hybrid automatic repeat request (HARQ) information to HARQ entity if the PSSCH duration has SL grant.
3) Step 3: HARQ entity determine initial transmission or retransmission, and for initial transmission, associate with a SL process, obtain MAC PDU from multiplexing and assembly entity (including logical channel prioritization (LCP) that select destination and logical channel and resource allocation based on starvation avoidance), set each field for SL grant, and deliver grant and MAC PDU to HARQ process.

As can be seen, the above procedure does not take the DRX configuration into consideration, and if the above procedure is applied to the SL DRX transmission, some issues may happen, which are explained below.

FIG. 3 illustrates another SL grant creation procedure performed by a UE in mode 2 according to some embodiments of the present disclosure.

In FIG. 3, at time t₁, data #1 in logical channel #1 is to be transmitted on sidelink. The data #1 in logical channel #1 is associated with a SL DRX configuration, and the active time corresponding to the SL DRX configuration is from time t₃ to time t₄. In this case, after resource selection, if the created SL grant is within the time duration from time t₃ to time t₄, the SL grant is appropriate. If the created SL grant is not within the time duration from time t₃ to time t₄, then the SL grant is inappropriate. For example, in FIG. 3, SL grant #1 is an appropriate SL grant while SL grant #2 is not. If SL grant #2 is created, the data cannot be transmitted because there is no SL grant during active time of the SL DRX configuration. Since the data is transmitted during inactive time of the SL DRX configuration, the Rx UE cannot receive the data.

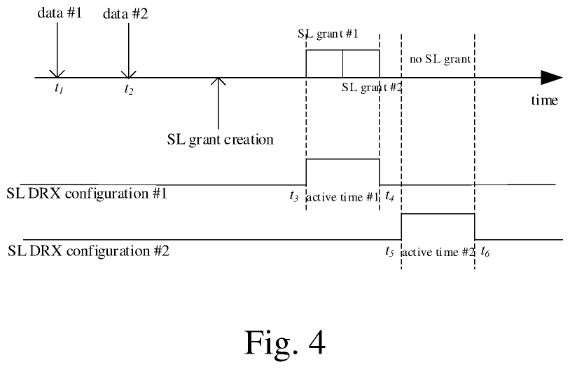

FIG. 4 illustrates another SL grant creation procedure performed by a UE in mode 2 according to some embodiments of the present disclosure. Specifically, the SL grant creation procedure is for different data in different logical channels.

FIG. 4 includes two data which are to be transmitted on sidelink, i.e. data #1 in logical channel #1, and data #2 in logical channel #2. Data #1 in logical channel #1 is associated with SL DRX configuration #1, and data #2 in logical channel #2 is associated with SL DRX configuration #2. The active time #1 of SL DRX configuration #1 is within the time duration from time t₃ to time t₄, and the active time #2 of SL DRX configuration #2 is within the time duration from time t₅ to time t₆.

For each sidelink process, the MAC entity may create a SL grant for the sidelink process. In FIG. 4, without considering the SL DRX configuration associated with the data, the MAC entity creates two SL grants, SL grant #1 and SL grant #2, which are both within the active time of SL DRX configuration #1, and there is no SL grant in the active time of SL DRX configuration #2. Correspondingly, data #2 cannot be transmitted.

That is, after DRX is utilized in SL transmission, data in different logical channels, or with different destinations, will be transmitted in different active times associated with the DRX configuration. Created SL grant may be different for different logical channels or different destinations because the active times associated with the DRX configuration may be different. Otherwise, there may be some active times of DRX configurations with no SL grant, and correspondingly, the data associated with the SL DRX configuration cannot be transmitted.

In view of the above, the present disclosure proposes a method for resources selection, to overcome the above issues.

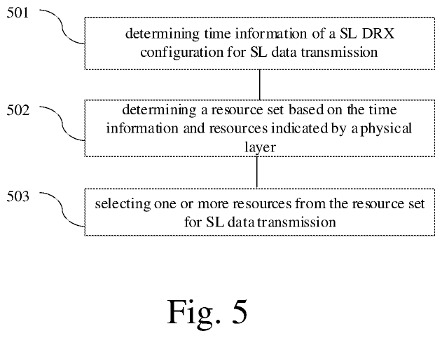

FIG. 5 illustrates a method performed by a UE for sidelink communication according to some embodiments of the present disclosure.

In operation 501, the UE determines time information of a SL DRX configuration for SL data transmission. The SL DRX configuration for the data that triggered the resource selection may be associated with Quality of Service (QOS) related parameter, the destination of the data, or the logical channel. The QoS related parameter may be the PQI.

Each PQI, each destination, or each logical channel may be configured with one SL DRX configuration. The UE may determine or derive one or more SL DRX configurations for each logical channel if the SL DRX configuration is per PQI or per destination. Similarly, The UE may derive one or more SL DRX configurations for each PQI if the SL DRX configuration is per destination or per logical channel.

The time information may be one or more active times, one or more transmission windows, one or more transmission durations, a series of active time, a series of transmission windows, a series of transmission durations, a periodical transmission duration with a period (e.g. 10 slots), etc. The active time here means a time window that transmitting UE should transmit the corresponding SL data, so that Rx UE is awake and can receive the SL data. The active time may be a time duration when the on duration timer is running, the inactivity timer is running, the retransmission timer is running, or the pre-defined time duration during which that the UE can transmit the data. For example, as shown in FIG. 4, the active time #1 of the SL DRX configuration #1 is a time duration from time point t₃ to time t₄, and the active time #2 of the SL DRX configuration #2 is the a time duration from time point t₅ to time t₆. Although not shown in the drawings, the time duration may be periodical, for example, the active time #1 is repeated every 10 slots, 100 slots, etc.

For a single MAC PDU transmission, if one active time is sufficient for the single MAC PDU transmission, the UE may determine one next active time of SL DRX configuration, and the single MAC PDU is transmitted during the next active time. If more than one active times are needed, the UE may determine one or more next active times, or one or more available active times. For multiple MAC PDU transmission, the UE may determine a series of active times of SL DRX configuration.

In operation 502, the UE determines a resource set based on the time information and resources indicated by the physical layer. Specifically, the MAC layer of the UE determines the resource set based on one or more active times and the resources indicated by the physical layer.

In operation 503, the UE selects one or more resources from the resource set for SL data transmission. The UE may select the time and frequency resources randomly, or select the resources based on pre-defined configurations.

The above resource selection method may be applied for performing both the broadcast and groupcast SL transmission, and it also may also be applied for SL unicast operation. For unicast SL transmission, if SL DRX is configured for a UE, the UE may trigger resource selection for the SL process associated with the SL DRX configuration, and if SL DRX is reconfigured for a UE, the UE may trigger resource reselection for the SL process associated with the SL DRX configuration.

The present disclosure also proposes to a solution for determining the logical channel for performing the SL DRX data transmission.

For each SL process, the UE may create a SL grant for the SL transmission if at least one logical channel has data to be transmitted.

First, the MAC entity determines a logical channel with data to be transmitted to associate with the SL process.

The logical channel may be following based on one or more of the following conditions:
1) Condition 1: no selected SL grant is created for the logical channel, that is, the UE in mode 2 has not created a SL grant for the logical channel.
2) Condition 2: no selected SL grant is created for associated active time of a logical channel, in other words, the UE in mode 2 has not created a SL grant which is within the associated active time the logical channel.
3) Condition 3: the logical channel has highest priority among logical channels determined to be starved. For each logical channel, it may have an associated priority value, which reflects the resource allocated to the logical channel, the number or the size of the SL grants that created for the logical channel. For example, during a LCP procedure, a value SBj is maintained for each logical channel and updated. The value SBj can also be updated before SL grant creation, or after SL grant is created for the SL process. SBj>0 means the logical channel has data in the buffer to be transmitted, but has not been transmitted or scheduled with SL grant for a certain time. If the logical channel has a SBj value that is greater than zero, it is determined that the logical channel is starved, and the MAC entity may select the logical channel.
4) Condition 4: no selected SL grant is created for the associated destination of the logical channel. In other words, the UE in mode 2 has not created a SL grant for the associated destination of the logical channel.

The above four conditions are exemplary conditions for determining a logical channel, and the present disclosure has no intention of limiting the conditions, other conditions for determining a logical channel also apply to the solution in the present disclosure.

It should be noted that the term “selected SL grant” refers to a SL grant created by a UE in mode 2, which is used to differ from the sidelink grant created by the BS for a UE in mode 1.

In one embodiment, for a UE in mode 2, if the MAC entity is configured to perform data transmission using pools of resources in a carrier based on sensing or random selection, for each SL process, the MAC entity of the UE checks and create SL grant if a logical channel has data to be transmitted. The UE then determines a logical channel which has data to be transmitted, to associate with the SL process.

Based on one or more conditions from the four conditions, the UE determines the logical channel. Then the MAC entity of the UE checks the conditions for the determined logical channels of the SL process during resource selection check or during the resource reselection check. The UE will perform resource selection or reselection for determined logical channels and SL process according to the method as described in FIG. 5.

In some other embodiment, after determining the logical channel, the MAC entity of the UE may also determine other logical channels which have the same destination and SL DRX configurations as the destination and SL DRX configurations of determined logical channel, and associate all these logical channels to the SL process. Then the MAC entity checks the conditions for determined logical channels of the SL process during resource selection check or during the resource reselection check.

Alternatively, the MAC entity of the UE may not check whether there are other logical channels which have the same destination and SL DRX configurations as the destination and SL DRX configurations of determined logical channel, and goes on to check the conditions for determined logical channels of the SL process during resource selection check or during the resource reselection check.

In some other embodiment, in order to create the SL grant, UE will check for each SL DRX configuration instead of check for each SL process. In other words, the UE may create the SL grant based on each SL DRX configuration.

Specifically, the UE may determine a SL DRX configuration whose associated logical channel(s) have data for transmission, and if there is data need to be transmitted during active time of SL DRX configuration, the UE will trigger SL grant creation for the SL DRX configuration.

The MAC entity determines a first logical channel for the SL DRX configuration, e.g. among all logical channels associated with the SL DRX configuration, select the logical channel which has the highest priority and has data to be transmitted. Then MAC entity may also determine other logical channels which have the same destination as the first determined logical channel and has data to be transmitted. Alternatively, the MAC entity may not check other logical channels. The SL grant is created for all determined logical channels.

The UE then performs resource selection or reselection check for the SL DRX configuration. For example, UE will check whether there is already a SL grant for the SL DRX configuration, and if the SL grant can fulfill the PDB and size of the data. The UE may also perform resource selection or reselection check for the the determined logical channel. If the SL grant is not suitable, or if there is no SL grant created for the SL DRX configuration, UE will select one or more resources for the SL DRX configuration.

If all the condition(s) are fulfilled, UE will select resource for the SL DRX configuration. Specifically, the UE will perform resource selection or reselection for the determined logical channels and SL process according to the method as described in FIG. 5.

In some embodiment, if the UE operates in mode 2, and the MAC entity has been configured to transmit using pools of resources in a carrier based on sensing or random selection, for each SL DRX configuration, the MAC entity of the UE may check and create SL grant when there are one or more logical channels having data to be transmitted on sidelink.

For each SL DRX configuration, the UE checks whether there is data need to be transmitted during active time of the SL DRX configuration. In some embodiments, the MAC entity may determine a logical channel with the highest priority and has data to be transmitted among all logical channels associated with the SL DRX configuration. For example, the logical channel with the priority value larger than zero, or a logical channel determined to be starved. Then the MAC entity determines other logical channels which have the same destination as the determined logical channel and has data to be transmitted. The SL grant is created for all determined logical channels.

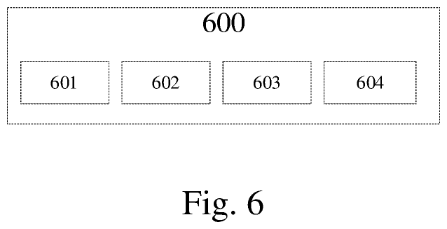

FIG. 6 illustrates a block diagram of an apparatus 600 according to some embodiments of the present disclosure. The apparatus 600 may include a receiving circuitry, a processor, a medium and a transmitting circuitry. In one embodiment, the apparatus 600 may include a non-transitory computer-readable medium 603 having stored thereon computer-executable instructions; a receiving circuitry 601; a transmitting circuitry 604; and a processor 602 coupled to the non-transitory computer-readable medium 603, the receiving circuitry 601 and the transmitting circuitry 604. The computer executable instructions can be programmed to implement a method (e.g. the method in FIG. 5) with the receiving circuitry 601, the transmitting circuitry 604 and the processor 602.

In another embodiment, the apparatus may include a processor; and a transceiver coupled to the processor, wherein the processor is configured to: determine time information of a SL DRX configuration for SL data transmission; determine a resource set based on the time information and resources indicated by a physical layer, and select one or more resources from the resource set for SL data transmission.

The method of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the drawings may be used to implement the processing functions of the present disclosure.

While the present disclosure has been described with specific embodiments thereof, it is evident that many alternatives, modifications, and variations will be apparent to those skilled in the art. For example, various components of the embodiments may be interchanged, added, or substituted in other embodiments. Also, all of the elements shown in each FIG. are not necessary for operation of the disclosed embodiments. For example, one skilled in the art of the disclosed embodiments would be capable of making and using the teachings of the present disclosure by simply employing the elements of the independent claims. Accordingly, the embodiments of the present disclosure as set forth herein are intended to be illustrative, not limiting. Various changes may be made without departing from the spirit and scope of the present disclosure.

In this disclosure, relational terms such as “first,” “second,” and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that comprises the element. Also, the term “another” is defined as at least a second or more. The terms “including.” “having,” and the like, as used herein, are defined as “comprising.”

1. A method performed by a user equipment (UE), the method comprising:
determining time information of a sidelink (SL) Discontinuous Reception (DRX) configuration for SL data transmission;
determining a resource set based on the time information and resources indicated by a physical layer; and
selecting one or more resources from the resource set for SL data transmission.

2. The method of claim 1, wherein the SL DRX configuration is associated with a corresponding Quality of Service (QOS) related parameter, a corresponding destination, a corresponding source, or a corresponding logical channel.

3. The method of claim 1, wherein the time information includes one or more transmission durations for SL data transmission that associated with a logical channel.

4. The method of claim 1, wherein the time information includes one or more next transmission durations for a single Media Access Control (MAC) Protocol Data Unit (PDU) transmission.

5. The method of claim 1, wherein the time information includes one or more periodic transmission durations for multiple Media Access Control (MAC) Protocol Data Unit (PDU) transmissions.

6. The method of claim 1, further comprising:
determining a logical channel for a SL process with no selected SL grant being created for the SL data transmission that associated with the logical channel.

7. The method of claim 1, further comprising:
determining a logical channel for a SL process with no selected SL grant being created for SL data transmission in a transmission duration of the logical channel.

8. The method of claim 1, further comprising:
determining a logical channel for a SL process with a highest priority among multiple logical channels that has data and starved, and optionally wherein the logical channel has no SL grant being created for SL data transmission in a transmission duration of the logical channel.

9. The method of claim 1, further comprising:
determining a logical channel for a SL process with no selected SL grant being created for SL data transmission of an associated destination of the logical channel.

10. The method of claim 6, further comprising:
associating one or more logical channels having a same destination and/or SL DRX configuration with determined logical channel.

11. The method of claim 6, further comprising:
performing resource selection check or resource selection for a determined logical channel.

12. The method of claim 1, further comprising:
determining a SL DRX configuration whose associated logical channels has data for transmission; and
determining a first logical channel which is selected from multiple logical channels associated with the SL DRX configuration and has the highest priority and with data to be transmitted.

13. The method of claim 12, further comprising:
performing resource selection check for the SL DRX configuration and the determined logical channel.

14. The method of claim 13, further comprising:
selecting resource for the SL DRX configuration and the determined logical channel when a created SL grant is not suitable for the SL DRX configuration, or no SL grant is created for the SL DRX configuration.

15. A user equipment (UE), comprising:
at least one memory; and
at least one processor coupled with the at least one memory and configured to cause the UE to:
determine time information of a sidelink (SL) Discontinuous Reception (DRX) configuration for SL data transmission;
determine a resource set based on the time information and resources indicated by a physical layer; and
select one or more resources from the resource set for SL data transmission.

16. A processor for wireless communication, comprising:
at least one controller coupled with at least one memory and configured to cause the processor to:
determine time information of a sidelink (SL) Discontinuous Reception (DRX) configuration for SL data transmission;
determine a resource set based on the time information and resources indicated by a physical layer; and
select one or more resources from the resource set for SL data transmission.

17. The UE of claim 15, wherein the SL DRX configuration is associated with a corresponding Quality of Service (QOS) related parameter, a corresponding destination, a corresponding source, or a corresponding logical channel.

18. The UE of claim 15, wherein the time information includes one or more transmission durations for SL data transmission that associated with a logical channel.

19. The UE of claim 15, wherein the time information includes one or more next transmission durations for a single Media Access Control (MAC) Protocol Data Unit (PDU) transmission.

20. The UE of claim 15, wherein the time information includes one or more periodic transmission durations for multiple Media Access Control (MAC) Protocol Data Unit (PDU) transmissions.
